(19) United States
(12) Patent Application Publication
(10) Pub. No.: US 2021/0059234 A1
(43) Pub. Date: Mar. 4, 2021

(54) CLEAR FLOATING FLY LINE WITH REDUCED REEL MEMORY AND METHODS OF MANUFACTURE

(71) Applicant: Flow Tek, Inc., Boulder, CO (US)

(72) Inventor: Robert H. Goodale, Boulder, CO (US)

(73) Assignee: Flow Tek, Inc., Boulder, CO (US)

(21) Appl. No.: 16/602,192

(22) Filed: Aug. 26, 2019

(51) Int. Cl. A01K 91/12; A01K 71/00; A01K 75/04; D07B 1/16

(52) U.S. Cl. CPC A01K 91/12; A01K 71/00; A01K 75/04; D07B 2205/2039; D07B 2501/2038; D07B 2205/201; D07B 1/162

(57) ABSTRACT

Improved fishing lines, and specifically fly lines, and methods of manufacture are shown. The line includes a copolyester ether material monofilament core line portion and a polyethylene copolymer coating portion providing highly improved toughness, line clarity and reel memory characteristics.

### FIELD OF THE INVENTION

This invention is related to fishing lines, and, more particularly, relates to fly fishing lines and methods.

### BACKGROUND OF THE INVENTION

Hydrophobic synthetic materials are known to be well adapted as fishing line, netting and the like, and, more particularly, composite lines made from such materials have been heretofore suggested and/or utilized for buoyant fly fishing lines.

For fly fishing, buoyant lines are often utilized. Such lines must have a specific gravity of less that about 1.15 or the surface tension of a still body of water will not be sufficient to keep the line afloat. However, since both the end of the leader and the fly (or lure) attached to the line are light weight, substantially all of the mass required for propelling, or casting, the fly to a desired position on the water is necessarily in the fly line itself. Moreover, while sufficient mass is required, bulk (cross-sectional size) of the line is desirably minimized to avoid undue wind resistance when casting.

Buoyant composite lines heretofore known and/or utilized have included lines having a braided filament core (see U.S. Pat. Nos. 5,625,976 and 8,857,147). Some lines use a vinyl plastisol coating, with the coating having microspheroids blended thereinto to promote buoyancy. Lines having a core made of the fiber known as KEVLAR with a polyester urethane coating which is foamed to provide a multiplicity of air pockets to promote buoyancy are also known (see, for example, U.S. Pat. No. 3,043,045).

Floating fly lines such as those heretofore known have always exhibited, because of the materials and/or methods utilized in their manufacture, at least some degree of opaqueness, transparent or substantially transparent floating fly lines being thus difficult to achieve. This is particularly the case when using multifilament core line where clarity remains an issue, the resulting lines always remaining somewhat cloudy. Moreover, again as a result of materials used, undesirable reel memory continues to be problematical for lines of these types. Here again, lines with multifilament core or nylon core materials are less desirable, exhibit significant reel memory, and are not susceptible to stretch of the sort that might straighten a curly line.

From the foregoing, it is apparent that a fly fishing line having a specific gravity which is low enough so that the line remains buoyant and lands consistently lightly on the surface of the water, while yet providing sufficient mass to maintain desired casting characteristics and cast distance, remains in demand. Such a line preferably remains supple and manipulable, is substantially free of abrasive surface characteristics, and exhibits little or no reel memory when stripped. Moreover, a substantially clear, or transparent floating fly line would be highly desirable to minimize the obtrusiveness of the fly line on the water, for example where low water levels are present and thus line presentation without substantial disturbance of fish is difficult at best.

### SUMMARY OF THE INVENTION

This invention provides improved fishing lines, and more particularly clear floating fly fishing lines (both primary lines and tippets, and leader/butt sections) and methods of manufacture. Lines of this invention have a specific gravity selected to allow line float without necessity of additional components. The lines are significantly clearer (i.e., transparent) than heretofore known lines, and exhibit greatly improved resistance to reel memory after spooling.

The clear floating fly lines of this invention utilize a copolyester ether elastomer material monofilament core line portion for improving finished line transparency and reel memory resistance, the finished line exhibiting little or no reel memory when stripped. The core line is coated with a selected thickness of polyethylene copolymer coating.

The elastomer material is non-halogenated and has a specific gravity less than 1.14. The polyethylene copolymer coating is an ethylene acrylic acid polymer and ethylene-based hexene plastomer copolymer having a specific gravity less than 0.94.

The methods of manufacturing clear floating fly fishing lines or this invention include providing (extruding, for example) a core line portion of copolyester ether elastomer monofilament and extruding a selected thickness of coating of polyethylene copolymer around the core line portion.

It is therefore an object of the invention to provide improved fishing lines and methods of manufacture and use.

It is another object of this invention to provide improved clear floating fly fishing lines, tippets and leaders.

It is another object of this invention to provide fly fishing lines that remain supple and manipulable, are substantially free of abrasive surface characteristics, and that exhibit little or no reel memory when stripped.

It is still another object of this invention to provide a floating fly line which is substantially transparent.

It is another object of this invention to provide a floating clear fly fishing line including a copolyester ether elastomer material monofilament core line portion and a polyethylene copolymer coating of selected thickness over the core line portion.

It is still another object of this invention to provide a floating fishing line that includes a non-halogenated copolyester ether elastomer material monofilament core line having a specific gravity less than 1.14, and a coating over the core line including a copolymer of ethylene acrylic acid polymer and ethylene-based hexene plastomer, the copolymer having a specific gravity less than 0.94.

It is yet another object of this invention to provide a method of manufacturing clear floating fly fishing lines that includes steps of providing a core line portion of copolyester ether elastomer monofilament and extruding a selected thickness of coating of polyethylene copolymer around the core line portion.

With these and other objects in view, which will become apparent to one skilled in the art as the description proceeds, this invention resides in the novel construction, combination, arrangement of parts and methods substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is an illustrative view of the fly line of this invention shown in use;

FIG. 2 is an enlarged cross sectional view of the fly line of FIG. 1 taken along section line 2-2 thereof;

FIG. 3 is a diagrammatic illustration of the method of manufacture of this invention; and

FIG. 4 is a sectional illustration of a die used in the method of FIG. 3.

### DESCRIPTION OF THE INVENTION

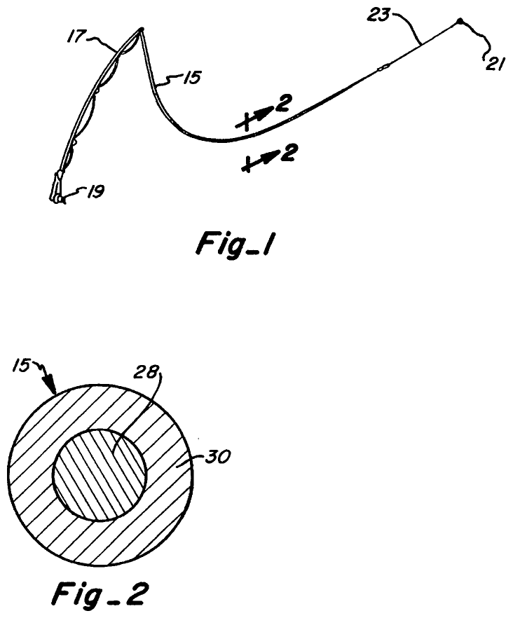

Referring to the drawings, fly line 15 of this invention is shown in FIG. 1 in use in association with fly fishing rod 17 and reel 19 for casting lure, or fly, 21. Fly 21 is attached to line 15 using tippet, leader and/or butt section 23. The fly, leader, and line are all configured for floating on the surface of a body of water, still or flowing. As shown if FIG. 2, line 15 includes core line 28 and coating portion 30. The core line portion is preferably a monofilament or hollow core monofilament fiber. The coating portion is a polyethylene copolymer coating.

The clear, or transparent, floating fly line provided by this invention uses a core line portion 28 of a solid core monofilament of clear copolyester ether elastomer. A particularly well adapted elastomer of extrusion of core line portion 28 is the EASTMAN NEOSTAR elastomer FN006, a clear non-halogenated copolyester ether elastomer material with good chemical resistance and heat resistance, high temperature dimensional stability and flexibility without plasticizers, and solvent bondability. When extruded as a monofilament it is extremely clear and significantly more supple than nylon monofilament (both solid and hollow core varieties) and multifilament lines of all varieties. This material has a specific gravity of about 1.13 (nylon comes in at 1.14). This material is adapted to be coextruded with other profile materials in order to provide significant shape memory (thus reducing reel memory when spooled over time). The material exhibits low extractables, toughness, flex crack resistance, utility in harsh environments, and remains substantially clear and free of the blush or haze that can occur in high-temperature applications.

Core line 28 material preferred properties include an Inherent viscosity of about 1.16. A flow rate of 10 g/10 min, crystalline peak melting point of about 205° C. and crystalline temperature on cooling of about 140° C. are preferred, with thermal conductivity of about 0.19 W/m·K and coefficient of linear thermal expansion about 15×10−5/° C. Brittleness temperature should be less than about 75° C. and durometer hardness (Shore D) about 55. Tensile strength at break is preferably around 22 MPa and at yield about 14 MPa, while elongation at break is best at around 400% (38% at yield). Tensile modulus of 170 MPa, flexural modulus of 150 MPa are desirable. Water absorption over 24 hours immersion should not exceed about 0.4%.

The preferred copolymer for polyethylene material coating 30 is preferably a copolymer of ethylene acrylic acid polymer and ethylene-based hexene plastomer. For example, a coating of 50% by weight of extrusion coating ethylene-based plastomer resin with 50% by weight ethylene acrylic acid polymer containing 9.5% comonomer has been found to, in combination with the core material above, provide and exceptionally clear floating line having very little reel memory.

One plastomer found well adapted to the coating is Exxon Mobil's EXACT 3040 resin (pellet form), an ethylene-based hexene plastomer designed for monoextrusion and coextrusion coating applications. This material provides good adhesion qualities and a very low seal initiation temperature combined with high hot tack and seal strengths. It has a melt Index of 190° C./2.16 kg, 17 g/10 min and peak melting temperature of 96° C. Its Vicat softening temperature of 76° C., tensile striength at yield 640 psi, tensile strength at break 6500 psi and elongation at break 650% are well suited to the coating herein. Moreover, with haze at 0.8% and specific gravity of about 0.900 it is well adapted for clear floating coatings.

A well adapted ethylene acrylic acid polymer for the line coating herein is DOW PRIMACOR 3460 ethylene acrylic acid polymer (pellet form) containing 9.5% comonomer. This material is primarily used for heat seal coating for high speed packaging applications where low temperature processing is necessary. It is designed to provide excellent adhesion to various substrates with excellent hot tack and heat seal performance. This resin also offers outstanding resistance to delamination and excellent toughness. The melt flow of 20 g/10 min, tensile strength at yield of 1060 psi (2360 psi ultimate), elongation at break 590% and Vicat softening point at 72.2° C. make this material well suited to the application herein. This material has a specific gravity of about 0.938

Using the material above, a total specific gravity of the copolymer coating of less than 0.94 can be expected. Overall line specific gravity using the core and coating materials describe can be expected to provide a floating line across a wide range of line diameters.

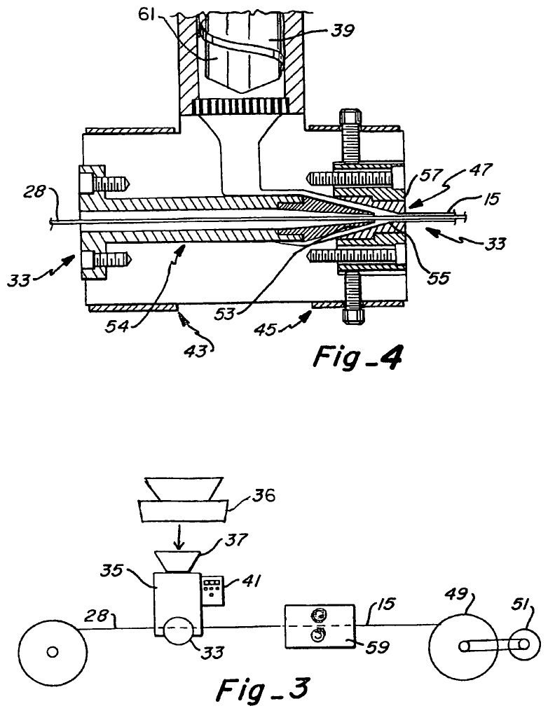

Application of the coating materials to the core is illustrated in FIGS. 3 and 4. Preferably, when utilizing blends, the selected different polymers are first dry mixed and extruded as discussed below. Core line 28 is formed with a desired diameter using standard extrusion techniques adapted to the material's characteristics. Once set and cooled, core line 28 is passed through crosshead die 33 of extruding unit 35. Polymer blend pellets are made available at grinding stage 36 whereat the pellets are ground in nitrogen and sifted as discussed hereinabove to the selected particle size. The ground polymer (and other components if desired) is fed to die 33 through hopper 37 by a single screw elongated mixing screw discussed above to plastic extruder 39. As the polymer mixture passes through the extruder and crosshead die, extrudate melt temperatures are reached depending on the material and the various zone temperature settings selected at control unit 41 for control of band heaters 43 and 45 (additional zones could be utilized if desired).

Die opening 47 size typically ranges from 0.025″ to 0.060″ depending on the weight of line to be produced. Line tapers (selectively varied thickness across line length) are achieved by varying the speed at which the core line passes through the die, for example by controlling puller 59 speed and/or the take up speed at reel 49 using motor 51. For example, a 0.052″ die opening with a core line speed of about 15 feet per minute and a selected screw speed will produce line diameters up to about 0.066″. By increasing line speed to about 30 feet per minute, line diameter drops to between about 0.048 to 0.052″. The belly of the lines herein are preferably fed at a rate of between about 10′ and 30′ per minute producing coating thicknesses up to about 0.040″. Core line speeds may vary (and die opening sizes may be adjusted) as necessary to achieve a selected line diameter. For example, coating thicknesses of about 0.006″ can be accommodated. To accommodate centering of core line 28 relative to die opening 47 (i.e., so that an even distribution of coating materials is achieved), guider tip 53 of mandrel 54 is moved closer to outlet opening 55 of die holder 57 (to within about 0.060″, this gap normally being in the range of about 0.200″ for most better known operations).

Mixing screw 61 is a spiral fluted mixing screw having a low resistance flow. This design incorporates selected standard screw element segments and mixing/melting segments having mixing channels with various pitches and spacing. Cooling begins directly after exit from the die of the coated line at a cooler (a water bath or air bath for example). Thereafter, the line is preferably annealed post extrusion by winding the produced line on a large diameter spool (˜2 feet or greater) and exposing to heat in the range of about 220° to 240° F. for up to about 24 to 48 hours.

As may be appreciated from the foregoing, the steps taken in formation of the fishing lines of this invention are calculated to assure uniform coating. Specifically, through careful mixing of finely powdered components, better component mixing is obtained to enhance line characteristic options flexibility with regard to lubricity components, density, core selection, tapers, component incorporation, and coating stiffness/suppleness. Using the methods of this invention, formulation of desired line characteristics including exceptional line clarity and resistance to reel memory can be accomplished without regard to likely regional temperature where the line is to be used. The manufacturing method described herein does not use a primer to achieve a bond between the core and polymer coating. Although coating portion 30 may or may not be bonded to the core, it provides a tough and flexible envelop around the core that is highly resistant to circumferential cracks.

Mixing as taught above produces a uniform coating for fly fishing line applications, and is particularly well adapted to line formation having two or more different line diameters in a single produced line. The same materials utilized in the clear floating line described above may be utilized for the leader/butt section 23 of this invention. Alternately, with a specific gravity of 1.13 it is possible to use a length of uncoated core line material discussed above.

Line splicing with leader and the like can be accomplished conventionally, or by means of fusing where line and leader are of the same material. Where conventional knotting is used, a drop of glue applied to the knot will further enhance the splice. This splicing technique for leader to fly line may be further enhanced by adding a fluorescent pigment to the solvent mixture in order to provide a highly visible and floating indicator for the fly line. In addition, splicing techniques can be utilized for adding a sinking line section to a floating line.

What is claimed is:

1. A floating clear fly fishing line comprising:
a copolyester ether elastomer material monofilament core line portion; and
a polyethylene copolymer coating of selected thickness around said core line portion.

2. The fishing line of claim 1 wherein specific gravity of said material is about 1.13 and Inherent viscosity is about 1.16.

3. The fishing line of claim 1 wherein said copolymer coating is formed from of ethylene acrylic acid polymer and ethylene-based hexene plastomer, said mixture having a specific gravity less than 0.94.

4. The fishing line of claim 1 wherein said selected thickness is a selectively varied thickness across line length.

5. The fishing line of claim 1 wherein said material has a Shore D durometer hardness of about 55.

6. The fishing line of claim 1 wherein said material has a tensile modulus of about 170 MPa and a flexural modulus of about 150 MPa.

7. A floating fishing line comprising:
a non-halogenated copolyester ether elastomer material monofilament core line having a specific gravity less than 1.14; and
a coating around said core line including a copolymer of ethylene acrylic acid polymer and ethylene-based hexene plastomer, said copolymer having a specific gravity less than 0.94.

8. The fishing line of claim 7 wherein said material has an inherent viscosity of about 1.16 and a Shore D durometer hardness of about 55.

9. The fishing line of claim 1 wherein said core line portion is characterized by being substantially free of haze and by exhibiting significant shape memory thus reducing reel memory when spooled.

10. The fishing line of claim 1 wherein said coating copolymer is about 50% said ethylene acrylic acid polymer and about 50% said ethylene-based hexene plastomer.

11. The fishing line of claim 10 wherein said ethylene acrylic acid polymer contains about 9.5% comonomer.

12. The fishing line of claim 7 wherein said ethylene acrylic acid polymer has a specific gravity less than 0.94 and wherein said ethylene-based hexene plastomer has a specific gravity of about 0.9.

13. The fishing line of claim 7 wherein said fishing line has a specific gravity of less than 1.0

14. A method of manufacturing clear floating fly fishing lines including the steps of:
providing a core line portion of copolyester ether elastomer monofilament; and
extruding a selected thickness of coating of polyethylene copolymer around the core line portion.

15. The method of claim 14 wherein the step of providing a core line portion includes extruding the core line portion having a desired diameter and cooling to set the core line portion before extruding the coating thereon.

16. The method of claim 14 wherein the step of extruding the coating includes passing the core line portion through a crosshead die and coating the core line portion thereat.

17. The method of claim 16 wherein the coating of polyethylene copolymer includes ethylene acrylic acid polymer and ethylene-based hexene plastomer, said method further comprising feeding approximately equal amount by weight of the polymer and the plastomer in pellet form to a grinder feeding the crosshead die.

18. The method of claim 16 wherein the step of extruding a selected thickness of coating includes varying at least one of crosshead die opening size and speed of passage of the core line portion through the crosshead die.

19. The method of claim 14 wherein the coating of polyethylene copolymer includes ethylene acrylic acid polymer and ethylene-based hexene plastomer, said copolymer characterized by specific gravity of less than 0.94.

20. The method of claim 14 wherein the core line portion is characterized by specific gravity of about 1.13.
